(19) United States
(12) Patent Application Publication
(10) Pub. No.: US 2014/0213227 A1
(43) Pub. Date: Jul. 31, 2014

(54) MOBILE DEVICE CAPABLE OF SUBSTANTIALLY SYNCHRONIZED SHARING OF STREAMING MEDIA, CALLS AND OTHER CONTENT WITH OTHER DEVICES

(71) Applicant: Bindu Rama Rao, Laguna Niguel, CA (US)

(72) Inventor: Bindu Rama Rao, Laguna Niguel, CA (US)

(21) Appl. No.: 13/752,340

(22) Filed: Jan. 28, 2013

(51) Int. Cl. H04W 4/20

(52) U.S. Cl. CPC H04W 4/206
USPC 455/414.3

(57) ABSTRACT

A mobile device that receives a streaming content that it shares with other devices in its vicinity/proximity. The mobile device comprises a communication circuitry that facilitates establishing a communication link with a plurality of other mobile devices. The mobile device receives the streaming content and shares it with substantial synchronization with the plurality of other mobile devices in real time employing the communication circuitry. The mobile device manages synchronized viewing of the streaming content with the plurality of other mobile devices by coordinating pauses, buffering, resumptions, restarts and terminations based on events reported by the mobile device and by the plurality of other mobile devices it is communicatively coupled with.

### CROSS REFERENCES TO RELATED APPLICATIONS

The present application is a continuation-in-part (CIP) of U.S. Non-Provisional application Ser. No. 13/473,606 entitled MOBILE DEVICE CAPABLE OF SUBSTANTIALLY SYNCHRONIZED SHARING OF STREAMING MEDIA WITH OTHER DEVICES (Attorney Docket No. BRR2006US03-U2-CIP), filed on 17 May 2012, the complete subject matter of which is hereby incorporated herein by reference, in its entirety. The application Ser. No. 13/473,606 is a continuation-in-part (CIP) of U.S. Non-Provisional application Ser. No. 11/891,193 entitled MOBILE DEVICE CAPABLE OF SHARING SMS MESSAGES, EMAIL SCREEN DISPLAY LOCALLY WITH OTHER DEVICES (Attorney Docket No. 23041U503), filed on Aug. 8, 2007, the complete subject matter of which is also hereby incorporated herein by reference, in its entirety. The application Ser. No. 11/891,193 is a continuation-in-part (CIP) of U.S. Non-Provisional application Ser. No. 11/810,597 entitled MOBILE DEVICE SHARING PICTURES, STREAMING MEDIA AND CALLS LOCALLY WITH OTHER DEVICES (Attorney Docket No. BRR2006US02-U1), filed on Jun. 5, 2007, the complete subject matter of which is also hereby incorporated herein by reference, in its entirety.

The present application is a also a continuation-in-part (CIP) of U.S. Non-Provisional application Ser. No. 11/810,597 entitled MOBILE DEVICE SHARING PICTURES, STREAMING MEDIA AND CALLS LOCALLY WITH OTHER DEVICES (Attorney Docket No. BRR2006US02-U1), filed on Jun. 5, 2007, the complete subject matter of which is hereby incorporated herein by reference, in its entirety. The application Ser. No. 11/810,597 in turn claims priority to U.S. provisional application No. 60/849,715 (Attorney Docket No. BRR2006US02) filed on Jul. 7, 2006, the complete subject matter of both these patent applications is hereby incorporated herein by reference, in their entirety.

The present application makes reference to U.S. Provisional Application Ser. No. 60/819,464 entitled MOBILE DEVICE SHARING PICTURES, STREAMING MEDIA AND CALLS LOCALLY WITH OTHER DEVICES, filed on Jul. 7, 2006, the complete subject matter of which is hereby incorporated herein by reference, in its entirety.

### BACKGROUND

1. Technical Field

The present invention relates generally to the interactions between mobile device and other devices, and more specifically to the localized sharing of streaming content, email, SMS and other content with other mobile devices.

2. Related Art

Electronic devices, such as mobile phones and personal digital assistants (PDA's), often contain small screens with very limited viewing area. They are constrained in terms of how much information can be displayed, and in terms of user interaction capabilities. Quite often when a user gets a phone call, he cannot let his friends in proximity listen to the voice conversation conducted over the phone, especially if the premises is noisy. Some phones have a speakerphone that can be used to amplify the phone conversation such that it can be heard by a few individuals who are close to the phone. However, this requires all the individuals who want to hear the conversation to be very close to the phone. Thus sharing incoming voice calls with others who want to listen to it, especially in noisy premises and in locations where people cannot huddle close to the phone, is quite impossible if not impractical. Conference call facilities are available on a cell phone. However, it is more expensive in terms of call time and it also requires the use of additional network resources. Thus, there is no easy way to share an incoming call with others who want to listen to it, especially in crowded or noise places and in places where people are not too close to each other although they are in the vicinity.

Sometimes, when a user receives a SMS message, the user may want to share it with a friend or spouse in physical proximity, but yet not close enough to view the mobile device. However, forwarding or resending the received SMS to share it with others will incur additional charges, and will also require the availability of the wireless network and services, which may be inaccessible. Similarly, email received by a user cannot be shared with others in close proximity without rerouting it back to the wireless network and back to the mobile devices of the others. In addition, there may be additional costs incurred or resources needed to forward the emails (as is done over the Internet typically).

In general, for a user of a mobile device to share the information displayed on the mobile device with others in proximity, the user has to ask them to assemble around the mobile device and make them view the display on the mobile device. This is fairly limiting and not a good user experience, especially since the screen on the mobile devices are small and not convenient for simultaneous viewing by a group of people.

Quite often a user may want to share the content on his mobile device. The user has no easy way to share the viewing or listening experience with others in the premises without using the wireless network (to reroute the data/information for sharing), with extra costs associated with such sharing, and with the need to have the wireless network currently accessible and available. For example, this may not be possible inside buildings or tunnels or trains where wireless network access is often a problem.

Some mobile phones can receive MP3 songs etc. from a media store such as iTunes. However, they cannot share it with their friends how might have mobile devices of their own in proximity. They have to ask their friends to individually access them (by searching for the content, downloading them, etc.). Shared experience is not easy, especially simultaneous viewing/hearing of media that is available on the Internet. The problem with a group of friends individually downloading a media file, or watching it as it is streamed is that such group viewing where each user individually downloads from a remote server is prone to a lot of problems, not least of which is that they are experiencing a different part or a different portion of the media at any given time. It is a poor and noisy, if not a chaotic attempt at a shared experience.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

The numerous objects and advantages of the present invention may be better understood by those skilled in the art by reference to the accompanying figures in which:

FIG. 1 is a perspective diagram of a mobile device that is capable of locally sharing streaming media emails, SMS messages and data displayed on the mobile device with other devices in proximity, such as the mobile device;

FIG. 2 is a flow chart showing typical usage of a source mobile device, in accordance with the present invention, for sharing a SMS message received by the source mobile device with another recipient mobile device;

FIG. 3 is a flow chart showing typical usage of a source mobile device, in accordance with the present invention, for sharing an email message received by the source mobile device with another target mobile device;

FIG. 4 is a flowchart of a local sharing mobile device wherein a local sharing manager in the local sharing mobile device manages printing with a local sharing printer in its proximity;

FIG. 5 is a flowchart 505 that shows the operations of local sharing mobile device 107 as it provides tracking functionality for shared data;

FIG. 6 is a perspective block diagram of a local sharing network wherein more than one target devices can share media streams, emails, SMS messages, etc. locally with a source mobile device; and

FIG. 7 is a perspective block diagram of a local sharing environment wherein a wireless network provides various kinds of data services to a source mobile device, such as email, SMS, MMS and broadcast media.

FIG. 8 is a perspective block diagram of a local sharing environment wherein a network provides access to a media server, a video server, an audio server and a document server for accessing various kinds of media/information that is shared locally with other devices in proximity.

FIG. 9 is a network comprising a plurality of devices that communicate, wherein the devices can share content with each other.

FIG. 10 is a mobile device that receives a streaming content that it shares with other devices in its vicinity/proximity.

### DETAILED DESCRIPTION OF THE DRAWINGS

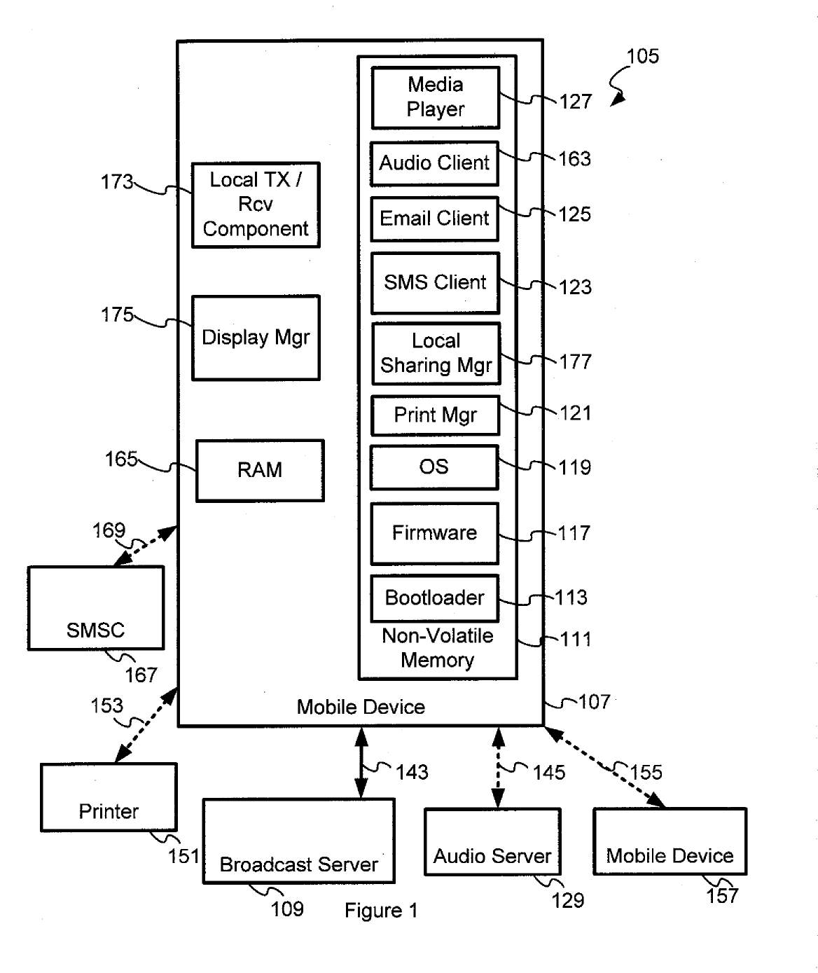

FIG. 1 is a perspective diagram of a mobile device 107 that is capable of locally sharing streaming media, emails, SMS messages and data displayed on the mobile device 107 with other devices in proximity, such as the mobile device 157. The mobile device 107 is part of a network 105, such as a wireless network, with access to voice and data services that make it possible for it to receive SMS, email and other types of data. The mobile device 107 is communicatively coupled with an SMSC 167 that provides SMS messages sent by other people, that can be viewed on the mobile device 107. It is also communicatively coupled to a broadcast server 109 and an audio server 129 via a WLAN or cellular wireless connections. The mobile device 107 can be used by a user to download audio and video content such as mp3, wma, MPEG2, MPEG3, etc. The mobile device 107 is communicatively coupled with the broadcast server 109, such as a DVBH server or a TV broadcast station, and to an audio server 129, such as an Apple iTunes server, a real-audio based streaming server, etc.

The mobile device 107 employs a local sharing manager 177 that makes it possible to share data with other mobile devices, such as a mobile device 157, for specific types of data managed or manipulated by client applications. For example, an email received by the email client 125 in the mobile device 107 is shared with the mobile device 157. Similarly, an SMS message received by the SMS client 123 in the mobile device 107 is shared with the mobile device 157. The local sharing manager 177 in the mobile device 107 facilitates the sharing of the SMS messages and the email messages with other devices in proximity, such as the mobile device 157 in local communication proximity.

In one embodiment, the email client 125 receives an email message from a mail server (such as an Exchange server) and the user reviews the email message received. When the user then decides to share the received email message with his spouse or friend using the mobile device 157, the user activates a local sharing key, for example a soft key. In response, the received email message is transferred to the mobile device 157 for local sharing, i.e. for display on the mobile device 157. Specifically, the email client 125 responds to the activation of the local sharing key by determining the email to be shared, packing the email data into a email packet for transfer to the mobile device 157, communicating the email packet to the local sharing manager of the mobile device 157, and confirming the communication of the email packet to the user of the mobile device 107 (such as via a display of a message box).

In one embodiment, the SMS client 123 receives a SMS message from a SMSC server (in a wireless network) and the user reviews the SMS message received. When the user then decides to share the received SMS message with his spouse or friend using the mobile device 157, the user activates a local sharing key, for example a soft key. In response, the received SMS message is transferred to the mobile device 157 for local sharing, i.e. for display on the mobile device 157. Specifically, the SMS client 123 responds to the activation of the local sharing key by determining the SMS message to be shared, packing the SMS data into a SMS packet for transfer to the mobile device 157, communicating the SMS packet to the local sharing manager of the mobile device 157, and confirming the communication of the SMS packet to the user of the mobile device 107 (such as via a display of a message box).

The mobile device 107 employs a local transmission and reception component 173, which is often a low power communication means such as Bluetooth, to communicate with the mobile device 157. The local sharing manager 177 in the mobile device 107 manages the establishment of the communication with the mobile device 157 and the subsequent local sharing, and the local transmission and reception component 173 supports local sharing as and when required, by providing one way, two way local or multi-point communication means (as necessary) between the mobile device 107 and the mobile device 157. For example, to locally share email and SMS messages, in one embodiment, the local transmission and reception component 173 provides a one-way communication such that the mobile device can share an email packet or an SMS packet with the mobile device 157.

The local sharing manager 177 facilitates sharing of instant messages, SMS messages and email messages received by the mobile device 107, such sharing occurring without the use of the cellular wireless network (or the wireless LAN network) on which the mobile device 107 typically operates. Thus, the local transmission and reception component 173 employs a protocol other than the RF protocols used for GSM or CDMA based wireless networking. It is based on protocols used for low power communication of devices that are in proximity, such as devices that are within 1 feet to 30 feet of each other, such as Bluetooth, or in some cases, 802.11 based protocols.

The local sharing manager 177 makes it possible to share the content currently being rendered, played or displayed by a mobile device 107, with another mobile device 157 in its vicinity. The local sharing manager 177 (sometimes referred to as the sharing client 177) also makes it possible to share the audio content currently being rendered, played or displayed by an audio client/player 163 in the mobile device 107. For example, the audio client 163 may be an Apple iTunes client, another MP3 player client, etc. In one embodiment, the local sharing manager 177 simultaneously conducts local sharing, such as that of an email as well as a streaming audio, etc.

The local sharing manager 177 makes it possible to share specific stored or streaming content (audio, or video) that is currently being displayed, played or rendered by a typical client in the mobile device 107, (such as the audio client 163 or the media player 127) with another mobile device in its proximity, such as the mobile device 157.

In one embodiment, the recipient mobile device 157 also comprises a local sharing manager 177 that is capable of negotiating sharing of email, SMS, media streams and other content with the local sharing manager 177 of the source mobile device 107. For example, it is capable of negotiating a channel for communication, buffer sizes, etc. In a related embodiment, the recipient mobile device 157 also comprises local sharing manager 177 that is capable of temporarily suspending sharing when an incoming phone call is received on it. It is also able to terminate sharing and letting local sharing manager 177 of the source mobile device 107 know that it is pausing or terminating sharing. In general, the recipient mobile device 157 is capable of starting, stopping, pausing and otherwise controlling the sharing of media streams and content with the local sharing manager 177 of the source mobile device 107.

The mobile device 107 is also capable of printing emails, SMS pictures, etc. using the local sharing manager 177, a printer manager 121, a printer 151 being used to print them using local sharing means. In one embodiment, the printer 151 comprises a local sharing manager component that makes it possible for the mobile device 107 to interact with and communicate the email, SMS message, picture and other information to the printer 151. In a related embodiment, the printer 151 employs an adapter (wireless or wired) that provides it with the facilities needed to interact with the mobile device 107 to provide local sharing printing support.

A display manager 175 in the mobile device 107 is used to manage what is displayed in the display of the mobile device 107. It is used to manage the display of text, graphics, video, etc. on an LCD screen (or other screens) on the mobile device. The display manager is implemented as hardware (chipset) in one embodiment and as a combination of hardware and software in another embodiment. The display manager 175 is used to print whatever is currently displayed in the mobile device 107, onto the printer 151. It employs the services of a print manager 121 to conduct printing on the printer 151, which in turn employs the services of the local sharing manager 177, if necessary, to establish communications with the printer 151 employing local sharing means.

The source mobile device 107 and the target device 157 (which may or may not be a mobile device) are capable of communicating over a locally sharing communication means, that is different from a wireless communication means, such as 3G, GSM, CDMA, GPRS, etc. typically employed for communication between the first mobile device 107 and a wireless network with which it is associated.

Using a local sharing manager, the mobile device 107 shares incoming calls, email, SMS messages, MMS messages, streaming media, pictures, etc. locally (without employing the cellular wireless network) with a target mobile device 157. The target mobile device 157 may also have a similar local sharing manager and be able to share locally with the mobile device 107.

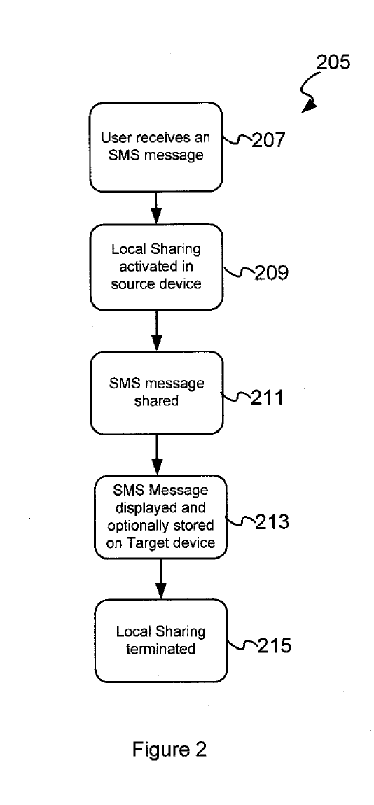

FIG. 2 is a flow chart 205 showing typical usage of a source mobile device 107, in accordance with the present invention, for sharing a SMS message received by the source mobile device 107 with another recipient mobile device 157. At a start block 207, the source mobile device receives a SMS message that a user can choose to view. Then the user can store it locally on the mobile device, delete it, or store it on the network side on a server. Then, at a next block 209, the local sharing manager 177 is activated in the source mobile device 107 by the user in order to share the received SMS message, which typically is the currently viewed SMS, with another person in communicative proximity (local communication, not using the cellular wireless network or equivalent IP based networks). In one embodiment, the user is prompted with a list of users (names of users) with whom the user can conduct local sharing, such a list having been registered previously with the local sharing manager 177. In a related embodiment, the local sharing manager 177 determines a list of currently available local sharing participants among a previously registered list of local sharing participants and lets a user choose one or more of the currently available local sharing participants (i.e. their mobile devices) as targets for sharing. The local sharing may be preconfigured such that the list of one or more recipient devices is known to the source mobile device 107. In one embodiment, the local sharing may also be accompanied by a discovery process where, based on user input that is solicited, or based on pre-configured preferences, the local sharing manager 177 discovers the target devices (such as mobile device 157) and starts negotiating the transmission of the SMS packet (or email, screen dump, etc.) to the target device(s).

Then at a next block 211, transmission of the SMS packet that comprises the SMS message occurs for the purposes of sharing locally with one or more recipient devices. The SMS client determines the content of the SMS packet, and communicates it to the local sharing manager 177 for communication to the target devices. The local sharing manager then interacts with the local transmission and reception component 173 to have the SMS packet (data packets in general) sent to the target device(s). In a related embodiment, the SMS client determines the content of the SMS packet, and communicates it directly to local transmission and reception component 173 for communication to the target device(s).

At a next block 213, receiving of the locally shared SMS packet for sharing is initiated in the target mobile device(s). The user of the target device can view the displayed SMS packet, and optionally store it. For example, the locally sharing manager in the mobile device 157 receives the locally shared SMS packet and communicates it to the SMS client in the mobile device 157 for display to the user of the mobile device 157. The user is also provided with an opportunity to save it locally in the mobile device 157.

Then, at a next block 215, the transmission of the locally shared data, such as the SMS packet, is terminated.

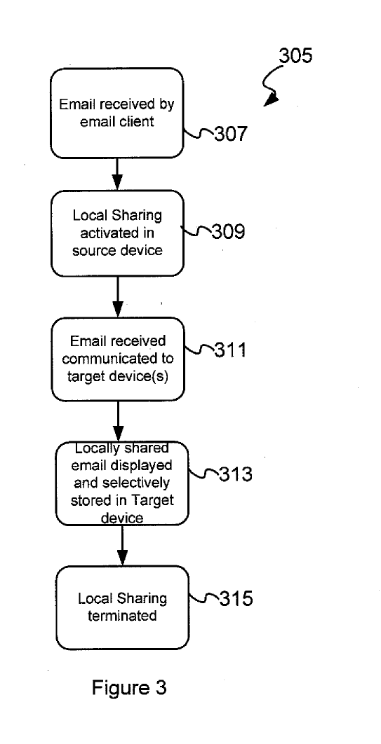

FIG. 3 is a flow chart 305 showing typical usage of a source mobile device 107, in accordance with the present invention, for sharing an email message received by the source mobile device 107 with another target mobile device 157. At a start block 307, the email client in the source mobile device 107 receives an email message that a user can choose to view. The user can store it locally on the mobile device 107, delete it, or store it on the network side on a server. Then, at a next block 309, the local sharing manager 177 is activated in the source mobile device 107 by the user, in order to share the received email message, which typically is the currently viewed email in the email clainet, with another person in communicative proximity (local communication, not using the cellular wireless network or equivalent IP based networks). In one embodiment, the user is prompted with a list of users (names of users) with whom the user can conduct local sharing, such a list having been registered previously with the local sharing manager 177. In a related embodiment, the local sharing manager 177 determines a list of currently available local sharing participants among a previously registered list of local sharing participants and lets a user choose one or more of the currently available local sharing participants (i.e. their mobile devices) as targets for sharing. The local sharing may be preconfigured such that the list of one or more recipient devices is known to the source mobile device 107. In one embodiment, the local sharing may also be accompanied by a discovery process where, based on user input that is solicited, or based on pre-configured preferences, the local sharing manager 177 discovers the target devices (such as mobile device 157) and starts negotiating the transmission of the email packet (or SMS, screen dump, etc.) to the target device(s).

Then at a next block 211, transmission of the email packet that comprises the email message occurs for the purposes of sharing locally with one or more recipient devices. The email client determines the content of the email packet, and communicates it to the local sharing manager 177 for communication to the target devices. The local sharing manager then interacts with the local transmission and reception component 173 to have the email packet (data packets in general) sent to the target device(s). In a related embodiment, the email client determines the content of the email packet, and communicates it directly to local transmission and reception component 173 for communication to the target device(s).

At a next block 313, receiving of the locally shared email packet for sharing is initiated in the target mobile device(s). The user of the target device can view the displayed email message in the email packet, and optionally store it. For example, the locally sharing manager in the mobile device 157 receives the locally shared email packet and communicates it to the email client in the mobile device 157 for display to the user of the mobile device 157. The user is also provided with an opportunity to save it locally in the mobile device 157.

Then, at a next block 315, the transmission of the locally shared data, such as the email packet, is terminated.

It should be noted that the sharing of a current email can be terminated by the user of the source mobile device. In addition, the recipient device also facilitates termination of sharing of the email, such as when it determines that it is about to receive its own incoming voice call.

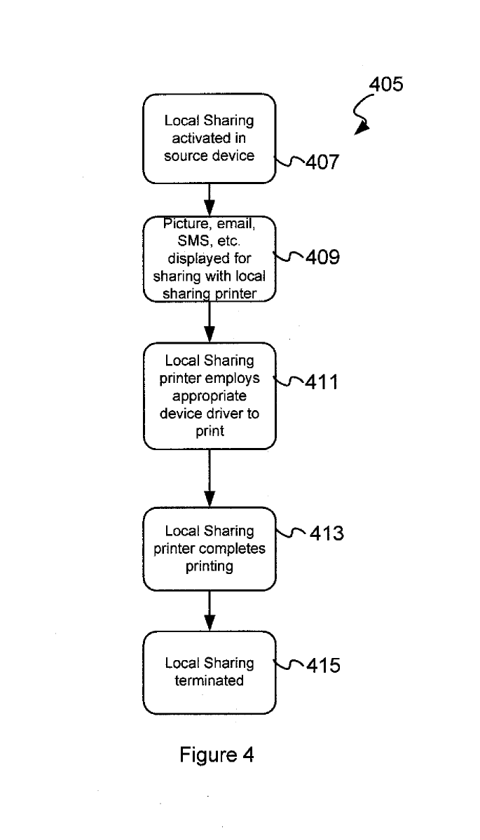

FIG. 4 is a flowchart of a local sharing mobile device 107 wherein a local sharing manager in the local sharing mobile device 107 manages printing with a local sharing printer in its proximity. At a start block 407, the local sharing manager 177 is activated in the source mobile device 107. The local sharing manager 177 facilitates the discovery of other devices in proximity, including a local sharing printer, if any. In one embodiment, where the connectivity with other devices for sharing is over Bluetooth protocols, it discovers other Bluetooth devices and establishes pairing with them.

Then, at a next block 409, the user displays a picture using a picture client or a camera client, an email using an email client, an instant message using an IM client, etc. The display manager 175 facilitates the display of the email message, the picture, etc. Such a display manager 175 is equipped with the capability to share the displayed content with a local sharing printer, such as the printer 151. The user has to activate printing with a local sharing printer and the local sharing printer is sent the appropriate printing data packet comprising the picture, email, SMS message, etc.

Then, at a next block 411, the local sharing printer employs the appropriate device driver to print the information being shared. To print emails and SMS messages, it employs a simple text print driver. To print a picture, the whole screen (current screen) or an image, it employs a image print driver. Thus, appropriate drivers are employed for the different types of data being printed.

Then, at a next block 413, at the end of the data transfer, such as a picture, the printing is completed. Then, at a next block 415, the local sharing is terminated. In one embodiment, all established local connections are also terminated. In another embodiment, all established local connections are continued in anticipation of a subsequent media sharing event.

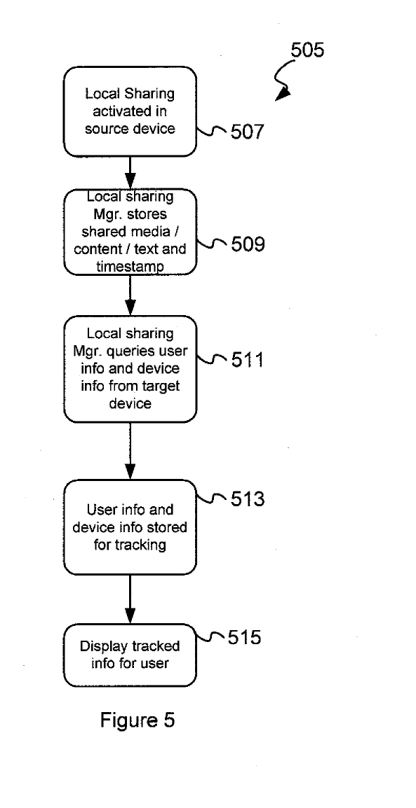

FIG. 5 is a flowchart 505 that shows the operations of local sharing mobile device 107 as it provides tracking functionality for shared data. The mobile device 107 is capable of local sharing and tracking of shared data by means of low-power local broadcasts. Local sharing broadcasts can be terminated either by a user of the sharing device or at the end of a local sharing episode, such as the end of a media stream or data that is broadcast.

At a start block 507, the local sharing manager of the source mobile device 107 is activated. The user can activate it to share received or played media, or the local sharing manager is configured to be activated when specific types of events occur, such as the receipt of email, the receipt of SMS messages, the receipt of incoming calls or the download of a song. Then, at a next block 509, local sharing occurs. For example, the low power broadcast of the media stream or media content currently being played in the source mobile device is initiated. Such broadcasts can be over a local FM radio frequency channels, over Bluetooth connections, over IrDA links, over WLAN connections, etc. In addition, the locally shared media, email, SMS, etc. is stored along with a log of the user with whom such sharing occurs, the timestamp of the sharing event, the device details of the target/recipient sharing mobile device(s), etc. For example, the tracking of the sharing event may comprise of information regarding the media or content being shared locally, the timestamp of when the sharing occurred, a target/recipient device details, user details if available, etc. Such information can be used for charging record creation, which may be subsequently used for billing purposes.

Then, at a next block 511, if user info and device detail information is not available, the local sharing manager of the source mobile device 107 queries user info and device information from the target mobile device(s) 157. Then, at a next block 513, the user information and device information are stored for tracking purposes. Finally, at the next block 515, the tracking information is displayed to the user at the end of the local sharing episode. In one embodiment, the user information and device information are not stored for tracking purposes in the block 513. Instead, at the end of the local sharing episode at the block 515, the display of tracked information, i.e. the user information and the device information and associated timestamp, occurs, with a prompt to the user to store the tracking information. If the user agrees to store the tracking information, then it is locally stored in the locally sharing source mobile device 107. In a different embodiment, the tracking also occurs in the target mobile device(s) 157 at the end of the local sharing episode.

In one embodiment, the local sharing, such as media broadcasts and sharing of email, SMS etc., are continued regardless of the presence of at least one listener, i.e. a recipient mobile device 157. In a different embodiment, the source mobile device 107 is able to determine if at least one recipient mobile device 157 is currently connected and able to listen to the shared media stream and the source mobile device 107 does not broadcast or locally share if it determines that no recipient mobile device 157 is currently able to receive the broadcasts (i.e. not connected or in the range on the low powered local broadcasts).

In one embodiment, a source mobile device 107 and a target client device 157 share media and textual messages (email, SMS, etc.) locally when the source mobile device 107 receives a media stream (such as a download of an MP3 song, or an incoming voice phone call) or email, SMS etc. The local sharing is setup by selecting a common communication channel, such as a FM station on the target mobile device(s) and the same FM station on the source mobile device 107.

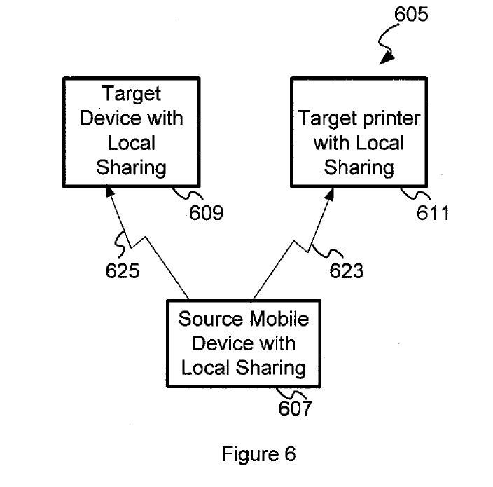

FIG. 6 is a perspective block diagram of a local sharing network wherein more than one target devices 609, 611 can share media streams, emails, SMS messages, etc. locally with a source mobile device 607. Low power local communication means such as Bluetooth connectivity or IrDA, etc. are used for locally sharing data. The source mobile device with Bluetooth 607 is capable of broadcasting media streams to more than one listening client devices 609, 611 over Bluetooth connections. Thus incoming emails, SMS messages, voice calls, downloaded streaming audio songs, etc. are shared with one or more listening client devices 609, 611 by a source mobile device 607.

In one embodiment, a Bluetooth based broadcast of locally sharable data, such as screen shots or pictures taken by a camera, is facilitated by the local sharing manager 177. Bluetooth radios connect to each other in piconets, which are formed by a master radio simultaneously connecting up to seven slave radios. As such, in a related embodiment, up to seven target listening devices are able to receive shared media streams transmitted by a source mobile device 107, such as a mobile phone.

In particular, the source mobile device with local sharing 607 is capable of sharing email, SMS messages, pictures, etc. with the target device with local sharing 609 but also with a target printer with local sharing 611.

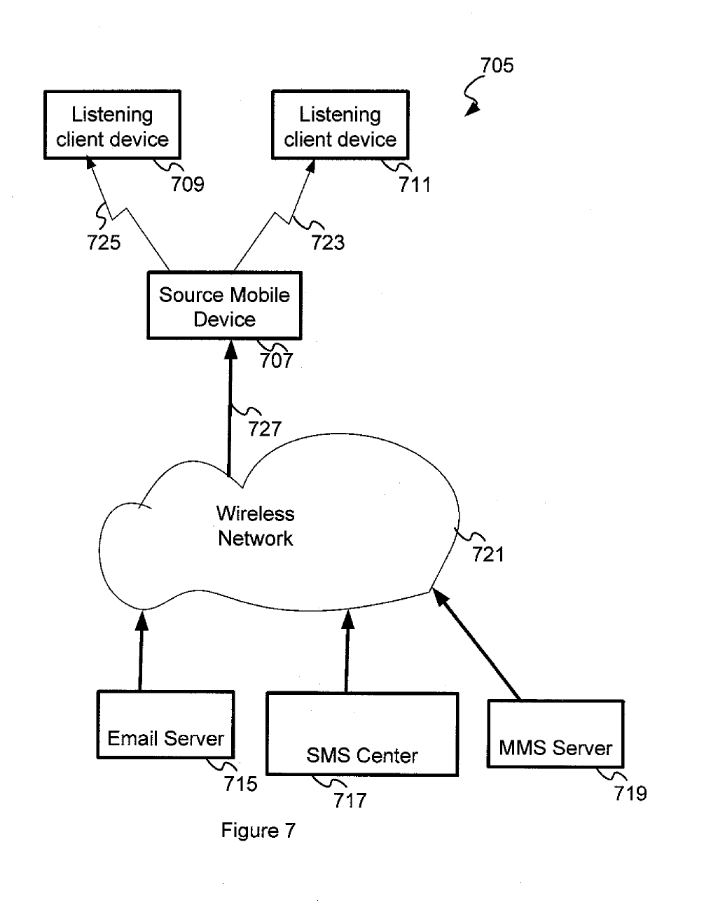

FIG. 7 is a perspective block diagram of a local sharing environment 705 wherein a wireless network 721 provides various kinds of data services to a source mobile device 707, such as email, SMS, MMS and broadcast media. The source mobile device 707 is capable of receiving online broadcast data, email messages, SMS messages, multi-media messages as well as voice calls. The source mobile device 707 receives them and shares them locally with one or more listening client devices 709, 711. The local sharing conducted by the mobile device 707 with the one or more listening client devices 709, 711 does not involve the wireless network 721. Only the source mobile device 707 is directly connected to or associated with the wireless network 721. The listening clients 709, 711 may not even be on the same wireless network 721—instead they may be subscribers of a different wireless (or wired) network altogether.

In one embodiment, the listening clients 709, 711 each comprise a local sharing manager, just as the source mobile device 707 does. The local sharing manager of the source mobile device 707 interacts with the local sharing managers of the other devices, such as the listening clients 709, 711, and it coordinates the sharing experience of the users. It negotiates communication of content shared, the tracking of shared content and the recipient devices, the timestamp, etc. It also exchanges signals to start, stop, pause, resume sharing based on incoming phone calls, or based on instructions from a respective user of the corresponding devices.

In a related embodiment, based on a type (such as a mime-type, for example) of the content being shared, the local sharing managers of listening client devices 709, 711 invoke an appropriate client software or mobile application to display/present the shared content to a user. Thus, an appropriate client software or mobile application is triggered for the duration of the sharing experience, or for the display of a shared email message, SMS message or instant message, etc.

The source mobile device 707 employs 3G, GPRS, GSM, VoIP, CDMA, WCDMA, UMTS or other standard wireless protocols to interact with the wireless network 721, and with an email server 715, an SMS center 717, an MMS serve 719 or a call client device via the wireless network 721. It uses other low power local sharing protocols to locally share content, such as received emails, SMS messages, MMS messages, voice calls or streaming media, with the listening client devices 709, 711. For example, it employs Bluetooth or 802.11 based protocols for local sharing.

A set of menus are provided by the source mobile device 707 to let the user initiate local sharing, provide information that can help in the configuration of local sharing and for the termination of local sharing of received calls and broadcast/multicast media. Broadcast media received are retransmitted to the local client devices 709, 711, over different communication means than the one they are received on. Multicast media may selectively forwarded to local client devices 709, 711 using appropriate protocol translations or bridging.

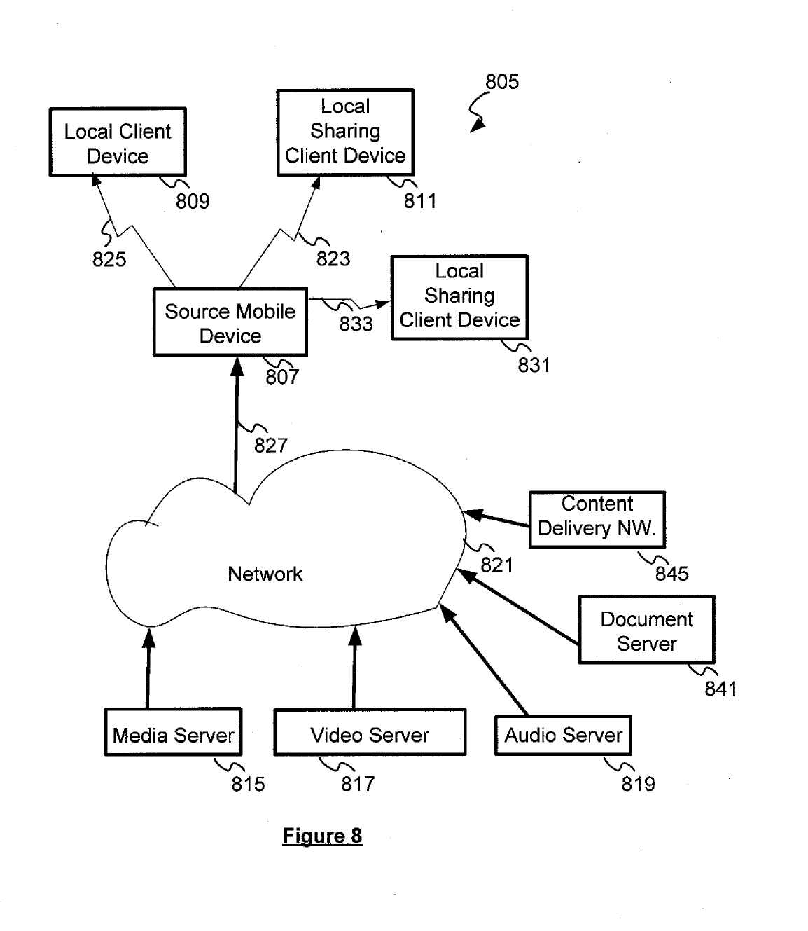

FIG. 8 is a perspective block diagram of a local sharing environment 805 wherein a network 821 provides access to a media server 815, a video server 817, an audio server 819, a document server 841 and a content delivery network 845 for accessing various kinds of media/information that is shared locally by a source device 807 with other devices in proximity, such as a local client device 809, a local sharing client device 811 and a local sharing client device 831. More specifically, the local client device 809 listens to shared content but does not share its own content with other local devices. The local sharing client device 811 not only listens to shared content provided and presents it to a user but also shares content that it receives. The local sharing client device 831 can only share its content—it does not listen/present content shared by other devices 807, 809, 811 in proximity. Thus a variety of sharing modes and sharing devices are supported by the present invention. The local sharing client device 811 is a tablet device, a mobile device (such as a cell phone, PDA, etc.), a laptop, a Wifi router, a computer, etc. in some embodiments. The use of other devices to be used as local sharing client device 811 is also contemplated.

A sharing client module or application in the devices 807, 809, 811 implements a player stream acquisition retry logic that allows also enables the sharing client module/application to automatically reconnect, if it is temporarily disconnected from a shared media stream (such as due to issues with connectivity issues, coverage issues etc. on the associated devices). If after multiple retries the sharing client is still unable to make a connection to the stream, a message is displayed stating that the sharing client is unable to connect to the shared media stream.

An XML feed that contains metadata and URLs for shared content thumbnails and media assets, if available, is shared by the source mobile device 807 with the other devices with which it shares a content. This XML feed is used, for example, by an appropriate content player/renderer on the receiving device, such as by a video player to populate and play the shared content.

Often times, content such as video is encoded at several variable resolutions and several bitrates by a content provider, and a content delivery network 845 provides access to this content at an appropriate resolution and bitrate required by a source mobile device 807. Thus, the source mobile device 807 determines an appropriate resolution and bitrate factoring in the type of devices it is locally sharing with, or by dynamically determining synchronization issues other devices receiving the shared content seem to be experiencing. The source mobile device 807 thus determines an appropriate resolution and bitrate for the shared content, if it is an audio content or a video content, based on capabilities of other devices, or based on actual audio and video latencies, delays, synchronization problems, missed data, or buffering problems reported or experienced by the other devices it is currently sharing with. It then requests, for example the media server 815 or the video server 817, to provide the shared content employing the appropriate resolution and bitrate for the shared content. Thus, it makes use of techniques such as adaptive bitrate streaming supported by servers. In one embodiment, the source mobile device 807 selectively denies content sharing with a local device, such as the local sharing client device 811 for example, if it determines that the resolution and bitrates currently supported or requested by local sharing client device 811 is not appropriate for a good user experience, or is inappropriate (for example, not supported by) for other devices involved in local sharing experience. The source mobile device 807 can also selectively (based on configuration, user preferences, etc.) specify a condition for inclusion of a local device for locally sharing content, wherein the condition comprises a minimum resolution and bitrate. Thus devices that do not meet that criteria are not included in local sharing of some types of content (this can be for specific types of criteria, for example). In addition, if a device, such as local client device 809, that had previously requested a low resolution or a bitrate for a shared content subsequently indicates that is can handle a higher resolution and/or a bitrate, the source mobile device 807 attempts to bump up the resolution and bitrate for that content (such as by requesting a provider, such as the content delivery network 845, or the video server 817, etc.). This is done, in one related embodiment, after it determines if any of the other devices currently sharing have no problems with such changes, or are capable of handling the content at a higher resolution/bitrate, etc.

In one embodiment, the local sharing can be over different local sharing technologies—some local devices may employ Bluetooth and its variations, others can employ WiFi and the variations of WiFI, and some may even employ IR or microwave based technologies. Thus, individual local devices 807, 809, 811 and 831 may share their content employing one or more different local communication technologies and protocols. For example, communication link 825 and 823 may be based on 802.11n while communication link 831 may be Bluetooth based.

In one embodiment, the local sharing is “synchronized”, i.e. media that is shared is in substantially synchrony across all the shared device. Thus, a viewer viewing a shared media on one of the local devices, such as local client device 809, will be experiencing substantially similar audio and video presentation to those experienced by a user of the local sharing client device 811, i.e. they will be listening to the same segment (or substantially similar portion) of a song/music being shared, or viewing the same portion (or substantially similar portion) of the video currently being locally shared by the source mobile device 807. The source mobile device 807, for example, sends timecodes, using which the receiving devices that locally share content synchronize their presentation of content. For example, source mobile device 807 simply transmits timecodes and the receiving devices, such as local client device 809, seeks to the timecode, for example, when it is more than one second out of sync. If one of the receiving devices request a pause, the source mobile device 807 pauses and transmits a timecode at which the pause occurred.

In one related embodiment, to support synchronization, shared media is synchronized by the source mobile device 807 and the receiving local client devices 809, 811 using vertical interval time code (VITC), a form of SMPTE time code embedded as a pair of black and white bars in a video signal. Thus an encoder would employ VITC for encoding shared media. Encoders can also be synched using linear or longitudinal time code (LTC), which encodes SMPTE time code data as a Manchester-Biphase encoded audio signal. The use of other forms of timecodes is also anticipated.

In one embodiment, the receiving device in a locally sharing environment 805 may decide not to have synchronization, and present locally share content without attempting any synchronization. For example, the local client device 809 (actually a client app or module) can decide not to display a received content in a “synchronized” mode, based on user instructions, because of an inability to support synchronization, etc. It can then receive and display the shared content (such as a music video, a song, a movie, etc.) without synchronization while the other devices participating in the sharing, such as the source mobile device 807 and the local sharing client device 811, may continue to employ synchronization techniques such as VITC to experience a synchronized display/presentation/rendering of locally shared content.

In one embodiment, the source mobile device 807 receives a first content from an external server, such as the video server 817, with which it is communicatively coupled. It then dynamically retrieves a currently supportable parameters from the plurality of local client/mobile devices 809, 811 and determines an appropriate parameter set, wherein the supportable parameters retrieved from the plurality of local client/mobile devices 809, 811 each comprises at least a resolution and a bitrate. Frame rate is also useful in such selections to be used as a criteria. The source mobile device 807 communicates the appropriate parameter set to the external server 817 and from then onwards receives the first content based on the communicated appropriate parameter set. Thus, in the middle of the process of receiving a streaming media, or streaming content, especially one that has been provided by a content provider with multiple resolutions and multiple bitrates, the source mobile device 807 can change the requested resolution, bitrate, etc. and thus modify the bandwidth used, etc. It can then support more number of devices locally by factoring in their limitations and dynamically changing capabilities (that may vary by network coverage, load, battery status, temperature, etc.).

The local sharing environment 805 also supports adding new devices in the middle of a sharing event, selectively terminating/dropping devices during sharing, etc. It also supports assigning one device as a proxy to a sharing device (one that wants to share), and conducting sharing with other devices via the proxy device on behalf of the sharing device (the one that initiated sharing of content). It also supports receiving an audio on the Internet, and broadcasting it locally to other devices over FM radio frequencies by the source mobile device 807. Similarly, the source mobile device 807 can receive a video (such as a movie clip from YouTube or some such Internet server, etc.) and rebroadcast locally to other devices in proximity, such as local client device 809, and this rebroadcast can occur over WiFi, Bluetooth, or some other local communication means 825.

In one embodiment, the source mobile device 807 receives a content that it wants to share, from an external server 845, 815,817 or 819. It presents it to a user of the source mobile device 807. It also forwards it to the local sharing client device 831 for storage. The other client devices 809 and 811 receive an instruction to share the content locally, by getting it from the local sharing client device 831 where it has been stored and is available. In a related embodiment, the sharing is synchronized such that all the locally sharing devices 807, 809 and 811 are able to present the content to associated users in a substantially synchronized mode. In a related embodiment, the local sharing client device 831 is a network storage server (NAS) that is able to support simultaneous access of streaming content by the other local client devices 809, 811, such as over IP based streaming connections. In a related embodiment, the local sharing client device 831 is a streaming server (such as Wowza) and consumes a live RTMP stream provided by the source mobile device 807 and while it also provides a multicast streaming to the local client device 809 and the local sharing client device 811, in either RTMP, RTSP or HTTP Live. The streaming between the local sharing client device 831 and the local client device 809 and the local sharing client device 811 is also possible over each stream is a unicast stream for each device from the local sharing client device 831.

In one related embodiment, the source mobile device 807 adds cue points to the live stream it receives, which it communicates (those cuepoints in the order they appear) to other devices it wants to share with, or to the local sharing client device 831 which does the local sharing as a proxy for the source mobile device 807. Then, by sharing the cuepoints with other local sharing devices (over UDP for example, one cuepoint at a time), the source mobile device 807 can prompt the other devices to “synch up” to those cuepoints. This might require the source mobile device 807 to delay the local presentation of the received steaming content by a certain amount (2 seconds for example initially, or a configured number of frames, etc.), so as to provide sufficient delay to provide other devices the possibility of synching up. In one related embodiment, the cuepoints are timestamps. In another, the cuepoints are offsets from reference data. In another embodiment, the recipient mobile devices in a sharing experience, i.e. the 809 and 811, employ a rate-based feedback strategy by which, during reception of a shared content for display, the source mobile device 807 receives light-weight messages called feedback units transmitted periodically by the device 809, 811 to accurately estimate the playback instants of the shared content portions. It then adjusts the transmission of the shared content accordingly to achieve substantially simultaneous sharing/display.

In one embodiment, the source mobile device 807 implements intra-stream synchronization schemes that are based on data buffering and on the introduction of a delay before the play-out of buffered data packets (i.e., frames). Those synchronization schemes are rigid in some embodiments or adaptive in others. In rigid schemes, the play-out delay is chosen a priori in such a way that it accounts for the maximum network transfer delay that can likely occur across the local sharing client devices 809, 811. Rigid synchronization schemes work under a worst-case scenario assumption and accept the introduction of delays that may be longer than necessary, in order to maximize the synchronization guarantees they can offer even under demanding situations.

In some embodiments, the present invention employs synchronization schemes that compute (by the source mobile device 807, for example) the delay parameter continuously while streaming: an attempt is made to “guess” the minimum delay that can be introduced, while still ensuring synchronization under actual operating conditions. In order to enhance quality of service in terms of minimized play-out delay, those schemes accept some temporary synchronization inconsistencies and/or some data loss, in case the computed delay results are at times insufficient (due, e.g., to variations in network conditions) and may need to be corrected on the fly.

In one embodiment, the present invention employs an approach where frame rates are sacrificed to achieve synchronization. For example, the source mobile device 807 acts as a central controller that coordinates the behavior of other local sharing client devices 809, 811, and configures them to employ proper frame rates, synchronization schemes, buffer sizes, etc. Other synchronization schemes are also contemplated.

In one embodiment, a mobile device 807 shares content in a network that comprises a plurality of mobile devices 807, 809, 811, 831 that communicate with each other. The mobile device 807 shares a first content for simultaneous presentation with a first device 809, a second device 811 and a third device 831 among the plurality of devices, wherein the display of the first content in the mobile device 807 is substantially synchronized with its corresponding display in the first device 807, the second device 811 and the third device 831. The mobile device 807 receives from the second device 811 a first signal and pauses sharing of the first content. It subsequently receives from the second device 811 a second signal and resumes sharing of the first content. Later, the first device 809 continues to share the first content with the second device 11 on resumption of local sharing. If the mobile device 807 determines that the first content comprises synchronization information. It then synchronizes the local presentation of the first content employing the synchronization information. For example, it can communicate over UDP with the other devices in proximity and provide timecodes, or cuecodes (that provide cue to a reference point in the content) which the other devices can use to seek synchronization. In a related embodiment, a client in the mobile device is responsible for managing sharing of content, synchronization of content, etc.

The mobile device 807 receives from the second device 811 signals to start, stop, pause or otherwise control the sharing of the first content. It also responds appropriately to the received signals and manages the sharing of the first content.

In another embodiment, the local client device 809 is an IPTV and the source mobile device 807 locally shares a received content with the IPTV 809.

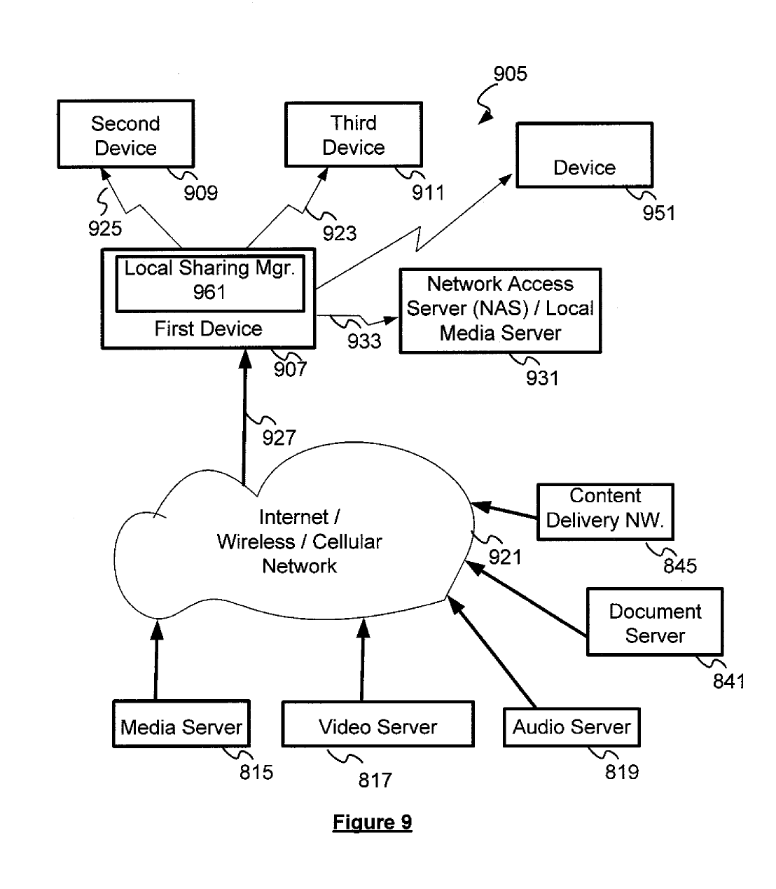

FIG. 9 is a network 905 comprising a plurality of devices that communicate, wherein the devices can share content with each other. The network comprises a first device 907 among the plurality of devices sharing a first content for simultaneous presentation with a second device 909 and a third device 911 among the plurality of devices. The second device 909 communicates a first signal and pauses receipt of the first content shared by the first device 907 with the second device 909. The second device 909 subsequently communicates a second signal and resumes receipt of the first content in the second device 909. The first device 907 continues to share the first content with the second device 909 on resumption. The second device 909 starts, stops, pauses and otherwise controls the sharing of the first content by the first device 907. The first device 907 continues to share the first content with the third device 911 when the second device communicates a pause signal and pauses receipt of the first content. The first mobile device 907 receives a content that it wants to share, from an external media server 815, external video server 817, external audio server 819, an external document server 841 or an external content delivery network 845.

In one embodiment, the first device 907 initiates the sharing of the first content, negotiates the transmission of the first content, starts, stops, pauses and controls the sharing of the first content with the those of the plurality of devices with which it simultaneously presents the first content. The first device 907 receives an incoming phone call and shares it with the plurality of devices 909, 911 after pausing the sharing of the first content for the duration of the incoming phone call.

In one embodiment, the first device 907 facilitates activation, by a user, of sharing of the first content from the first device 907, wherein the first content comprises synchronization information. The first device 907 facilitates substantially synchronized audio and video experience by the corresponding users of those of the plurality of devices 909, 911 with which it simultaneously shares the first content.

In another embodiment, the first device 907 receives the first content from an external server with which it is communicatively coupled. The first device 907 dynamically retrieves a currently supportable parameters from the plurality of mobile devices 909, 911 and determines an appropriate parameter set, wherein the supportable parameters retrieved from the plurality of mobile devices 909, 911 each comprises at least a resolution and a bitrate. The first device communicates the appropriate parameter set to the external server and receives the first content based on the communicated appropriate parameter set.

In yet another embodiment, the first device 907 pauses the sharing of the first content with the second device 909 and the third device 911 on receipt of the first signal from the second device or on the determination of the occurrence of an event of interest. It discovers another one 951 of the plurality of devices 909, 911, 951 as a new target available for sharing the first content and adds it as an additional recipient device for sharing of the first content by the network in the middle of the shared viewing of the media content by the first device 907 with the second device 909 and the third device 911. The newly added device 951 receives the remaining portion of the first content for substantially simultaneous consumption of the first content. (Alternatively, it starts the shared content from its beginning)

In one embodiment, the first device 907 solicits initiation and optional configuration of local sharing of the first content by a user of the first device 907 employing appropriate set of menus and prompts provided by the first device 907.

In a different embodiment, the first content is one of a broadcast content, a streaming content and a downloaded content. Each of the plurality of devices 907, 909, 911, 951 comprise a local sharing manager 961 that facilitates starting, stopping, pausing, resuming and otherwise controlling the sharing of the first content. The local sharing manager 961 in each of the plurality of devices 907, 909, 911, 951 is capable of receiving the first content and retransmitting it to the others of the plurality of devices for local sharing.

In one embodiment, the first device 907 communicates a synchronization information to the others of the plurality of devices 909, 911, 951 it is currently sharing first content with and in response, the others of the plurality of devices 909, 911, 951 ensure substantially synchronous presentation of the first content based on the synchronization information. In a related embodiment, the third device 911 buffers a portion of the first content that is being shared and the second device 909 receives the portion of the first content buffered by the third device 911, after communicating the resume signal. In addition, the second device 909 also resumes receipt of the first content from the first device 907 while it presents the portion of the first content buffered by the third device 911.

In one embodiment, the first device 907 controls the sharing of a received phone call with at least the second device 909 among the plurality of devices. A sharing client in the first device 907 interacts with the sharing clients in the others of the plurality of devices to share the first content, sending signals to start, stop, pause sharing, receiving signals to stop, start, pause sharing, etc. For example, it sends a first signal to the second device 909 indicating availability of a received phone call with a request to the second device respond with a status indicating a current ability to participate in sharing. On receiving a response indicating the current ability to participate (such as by a flag “yes”/“no”, or 1/0, etc.), it then sends meta information on the received call (such as phone number or identification of the caller, a quality of the connection, etc.) to the at least the second device, and then commences sharing of the received call. The first device 907 can communicate a pause signal to the at least the second device 909 among the plurality of devices to pause sharing when necessary, and subsequently send a resume signal or a terminate signal to resume the sharing of the received phone call or terminate it, respectively.

In a related embodiment, the second device 909 can also control the sharing experience, by sending appropriate signals to the device currently sharing the first content (received phone call, for example). For example, the second device 909 also comprises a local sharing manager similar to local sharing manager 961 of first device 907, and the second device 909, after initially participating in the sharing of the first content, i.e. receiving and displaying the first content as it is received, communicates a first signal to pause the receipt of the first content shared by the first device 907 in the second device. The second device 909 subsequently communicates a second signal to resume receipt of the first content in the second device. The first device 907 continues to share the first content with the second device on resumption until the first device 907 receives a third signal from the second device 909 instructing it to pause or terminate sharing of the first content with the second device. In another related embodiment, the first signal, the second signal and the third signal communicated by the second device to the first device 907 is also communicated to all the others of the plurality of devices currently participating in the sharing of the first content.

In a related embodiment, the first device 907 is capable of sharing a received call with the second device 909 and a third device 911 among the plurality of devices midway through a received phone call (i.e. after initially handling the call and letting a user interact on the phone call for a few seconds or minutes before sharing it).

The first device 907 is also capable of targeting devices for sharing, either automatically, or based on selection of one or more devices by a user. For example, in one embodiment, it determines target mobile devices from a plurality of mobile devices employing a local sharing manager in the first device 907, wherein the target mobile devices each comprise a corresponding local sharing manager. It then solicits user selection from the target mobile devices—the local sharing manager of the first mobile device 907 displays a list of target mobile devices and asks a user to select one or more from the list. Based on user selections, it assembles a target devices among the plurality of devices with which sharing of the first content will be initiated. The local sharing manager 961 of the first device 907 then starts negotiating the transmission of the first content to the target devices. After negotiations (wherein parameters may be exchanged, channel information may be exchanged, preferences may be exchanged, security keys exchanged if necessary, etc.), sharing of the first content by the first mobile device commences. In a related embodiment, the local sharing manager 961 (sometimes referred to also as the sharing client) of the first mobile device 907 also determines if at least one of the others of the plurality of devices is currently available and able to receive the streaming media, and then it commences sharing of the streaming media upon determining the list of those currently available devices. Sharing is subsequently terminated by the local sharing manager 961 of the first mobile device 907, after determining that no other device is currently able to receive the streaming media (or at the end of the transmission of the streaming media, for example). The local sharing manager 961 (sometimes referred to as the sharing client) of the first mobile device 907 keeps monitors as well as keeps track of all the content that is shared, the duration of sharing, a timestamp, information on recipient mobile devices with which sharing occurs, etc. This is selectively used for billing, tracking usage, solicitation of feedback from associated users, targeting users for advertisements and purchase offers, etc. Similarly, the local sharing clients of the recipient mobile devices keep track of sharing, collecting similar details, and making such data available selectively (based on security settings, user preferences, content types, etc.).

In a different embodiment, the local sharing manager 961/sharing client of the first mobile device 907 receives an indication of a receipt of an SMS message by an SMS client in the first mobile device 907, an indication of a receipt of an email message by an email client, or the an indication of a receipt of an instant message by an instant messaging client, etc. It then uses the sharing client to share that received content (SMS message, email message instant message, etc.). Thus, for example, the sharing client of the first mobile device 907 shares, as instructed by a user of the first mobile device 907, the associated SMS message, the email message or the instant message, with the others of the plurality of mobile devices. This involves interacting with corresponding local sharing clients in those other mobile devices, communication of the content/message, and subsequent display (for user review, etc.) by associated client applications (SMS client, email client, instant messaging client, etc.) in those other mobile devices.

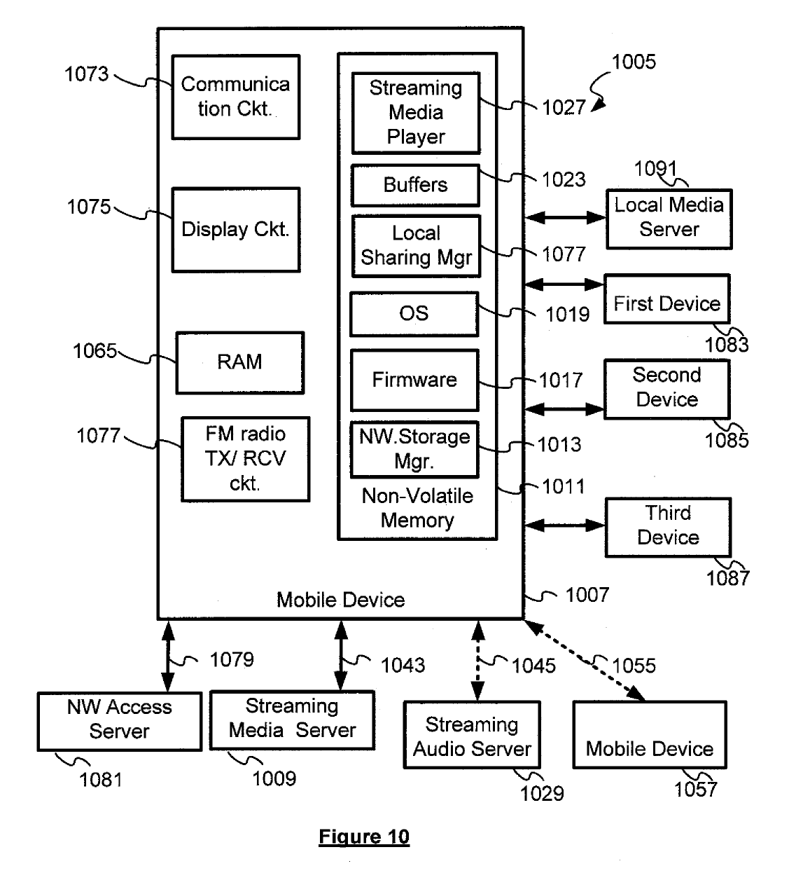

FIG. 10 is a mobile device 1007 that receives a streaming content that it shares with other devices in its vicinity/proximity. The mobile device 1007 comprises a communication circuitry 1073 that facilitates establishing a communication link with a plurality of other mobile devices 1057, 1083, 1085, 1087. The mobile device 1007 receives the streaming content and shares it with substantial synchronization with the plurality of other mobile devices 1057 in real time employing the communication circuitry 1073. The mobile device 1007 manages synchronized viewing of the streaming content with the plurality of other mobile devices 1057 by coordinating pauses, buffering, resumptions, restarts and terminations based on events reported by the mobile device and by the plurality of other mobile devices 1057, 1083, 1085, 1087 it is communicatively coupled with.

The mobile device 1007 comprises a streaming media player 1027 that is capable of receiving and playing streaming media (songs, movies, video clips, etc.), buffers 1023, a local sharing manager 1077, a network storage manager 1013, a firmware 1017 and an operating system (OS) 1019. Employing the local sharing manager 1077, the streaming media player 1027 shares any media/content it is currently displaying/presenting to a user. Employing the network storage manager 1013, the streaming media player 1027 stores media/content it has received (or is currently receiving/presenting) into a network access manager (not shown) that it is communicatively coupled to. It also comprises an FM radio transmitting/receiving circuitry 1077 that facilitates receiving media over FM radio waves, transmitting media over FM radio waves (for sharing locally), etc. For example, the mobile device 1007 can receive an audio program from the streaming audio serve 1029 and broadcast it over the FM radio transmitting/receiving circuitry 1077 locally in order to share it with other mobile devices 1057, 1083, 1085, 1087. It coordinates the sharing by sending details of the audio program to the other mobile devices 1057, such details, for example, comprising of a trigger to start sharing, the creator of the audio program, a title for it and other details associated with the program, an identification for an channel for sharing (receiving over the identified FM channel), etc.

In one embodiment, the mobile device 1007 comprises at least one buffer 1023 and the mobile device queues up at least a portion of the streaming content in the at least one buffer 1023 when any one of the plurality of other mobile devices 1057, 1083, 1085, 1087 or the mobile device 10007 initiates a pause signal. The mobile device 1007 distributes the buffered at least a portion of the streaming content to the plurality of other mobile devices 1057, 1083, 1085, 1087 when the device that initiated the pause signal subsequently communicates a resume signal.

In one embodiment, the mobile device 1007 receives or retrieves supportable parameters from the plurality of other mobile devices 1057, 1083, 1085, 1087 and the mobile device 1007 determines an appropriate parameter set from the supportable parameters received or retrieved from the plurality of other mobile devices 1057. It employs the appropriate parameter set in receiving or retrieving the streaming content from an external server, such as a streaming media server 1009, a streaming audio server 129, or even an external mobile device (not shown).

In another embodiment, the mobile device 1007 simultaneously shares the streaming content with the plurality of other devices 1057, 1083, 1085, 1087 and pauses sharing with all of them based upon a first event, resumes sharing based on a second event, and terminates sharing based on a third event.

In a different embodiment, the mobile device 1007 tracks the sharing activity by collecting information regarding the content being shared locally with the plurality of other mobile devices 1057, 1083, 1085, 1087 the timestamp of when the sharing occurred, a device details of the plurality of other devices 1057 that participate in sharing, and user details if available.

In one embodiment, the streaming media player 1027 is integrated/merged with the local sharing manager 1077, and is capable of playing streaming media (presenting it to a user), sharing streaming media (such as by retransmitting, rebroadcasting, storing in NAS for coordinated and/or synchronized access by other mobile devices 1057, 1083, 1085, 1087 etc.), forwarding interactive media, etc.

In one embodiment, the other mobile devices are one of a computer, a tablet, a laptop, a PDA, a WiFi router, a NAS, a cellular phone, an IPTV, and an IP Phone. For example, in an exemplary embodiment, the first device 1083 is a cellular mobile device, the second device is a 1085 tablet device, and the third device 1087 is an IPTV.

The mobile device 1007 shares a first content for simultaneous presentation with a first device 1083, a second device 1085 and a third device 1087 among the plurality of devices, wherein the display of the first content in the mobile device 1007 is substantially synchronized with its corresponding display in the first device 1083, the second device 1085 and the third device 1087. The mobile device 1007 receives from the second device a first signal and pauses sharing of the first content. The mobile device 1007 subsequently receives from the second device 1085 a second signal and resumes sharing of the first content. The mobile device 1007 continues to share the first content with the second device 1085 on resumption.

In one embodiment, the mobile device 1007 receives from the second device 1085 signals to start, stop, pause or otherwise control the sharing of the first content. It acts appropriately in response to the signals and manages the sharing of the first content. In a different embodiment, the mobile device 1007 receives the first content from an external server, such as the streaming media server 1009 over Internet, and shares it with the plurality of devices 1057, 1083, 1085, 1087. The mobile device 1007 dynamically retrieves currently supportable parameters from the plurality of devices 1057, 1083, 1085, 1087 and determines an appropriate parameter set, wherein the supportable parameters comprise a resolution, a bitrate and frame rate. The user of other parameters is also contemplated, such as quality of service, priority of services, security settings, client application availability, battery status, etc. It communicates the appropriate parameter set to the external server, such as the streaming media server 1009, and receives the first content based on the communicated appropriate parameter set. The mobile device 1007 continues the sharing of the first content with the plurality of devices 1057, 1083, 1085, 1087. In a related embodiment the mobile device 1007 shares the first content as it is received, in real time, from an external server, such as the streaming media server 1009.

In another embodiment, the mobile device 1007 shares the first content as it is received from an external server with a networked access server (NAS) 1081 or a local media server 1091 (a local one in the premises, that TVs, PCs, music systems and other local devices interact with and retrieve music, videos, etc.) communicatively coupled to the mobile device 1007 and to the plurality of devices 1057, 1083, 1085, 1087, for sharing it with the plurality of devices in real time, and determining a reference to it. The reference is a URL, using which the plurality of mobile devices can access the first content, play it back (in real time too). The reference is a unique identification in another related embodiment. Other types of references are also contemplated. The mobile device 1007 communicates the reference to the plurality of devices 1057, 1083, 1085, 1087 for substantially synchronized viewing with the plurality of devices.

In one embodiment, the mobile device 1007 shares the first content as it is received from an external server with a networked access server (NAS) 1081. It uses the NAS 1081 as a proxy for the mobile device 1007, in regard to sharing streaming media locally with other devices 1057, 1083, 1085, 1087. For example, the mobile device 1007 starts receiving a stream of media (such as a video) from the streaming media server 1009 and the mobile device 1007 not only presents it on its screen to a user, but also does the following:
a. Communicates a message to the NAS 1081 to instruct it to store it, and make it accessible, as it is being stored, to the other devices for shared substantially synchronized access.
b. Receives a reference to the stored streaming media
c. Coordinates substantially synchronized access by the others of the plurality of devices 1057, 1083, 1085, 1087 by communicating the reference to the stored streaming media, a configuration coordinate, an appropriate parameter set for the streaming media (such as one or more of a bitrate, resolution, frame rate, etc.)
d. As needed, communicated synchronization information, instructing the others of the plurality of devices 1057, 1083, 1085, 1087 to synch up to appropriate cuepoints or markers on the streaming media that facilitates substantially synchronized presentation across all the devices participating in the shared viewing.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

The terms “media” and “content” as used herein may refer to music, recorded voice inputs that a user records, videos, video clips, live transmissions of music and programs, and multimedia information accessed by a user. The media and content may be received by a mobile device in MP3 format, AMR format, WMA format, WMV, AVI format, MP4, MPEG based formats, DVD formats, HDDVD formats, PDF, PPT, Silverlight Smooth Streaming formats, etc.

The term “SMS” as used herein may refer to a textual content delivered over a text based messaging system, such as a text message service that can be provided over a WAP bearer (for example). It includes text messaging over IP networks, such as SMS over IP.

The term “email” as used herein may refer to textual and multi-media content delivered over an electronic mail service, such as mail and files delivered over a push or pull based mail delivery service. It includes textual and multi-media content delivered via a client pull service or a server push service.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A first mobile device in a network, the first mobile device comprising:
a sharing client to share a first content for simultaneous presentation with a plurality of other devices in a local network, wherein each of the plurality of other devices also comprise their own version of the sharing client;
the sharing client in the first device receiving from a sharing client of a second device among the plurality of devices a request for starting, stopping, pausing and otherwise controlling the sharing of the first content with the second device; and
the sharing client of the first device responding to the request from the second device by executing a corresponding action while continuing to share the first content with the others of the plurality of devices.

2. The first mobile device of claim 1 further comprising:
a SMS client that receives an SMS message and displays it;
an email client that receives an email message and displays it;
an instant messaging client that receives an instant message and displays it; and
the sharing client interacting with the SMS client, the email client and the instant messaging client and facilitating the sharing, of the associated SMS message, the email message or the instant message, with the others of the plurality of mobile devices, as instructed by a user of the first mobile device.

3. The first mobile device of claim 2 further comprising:
the sharing client receiving, for display to the user of the first mobile device, a first SMS message, a first email message or a first instant message from a second device, wherein the second device is one of the devices among the plurality of devices; and
the sharing client causing the display of the first SMS message, the first email message or the first instant message received from the second device, by employing one of the SMS client, the email client or the instant messaging client, respectively, as appropriate.

4. The first mobile device of claim 1 further comprising:
the sharing by the sharing client in the first mobile device triggered by specific types of events encountered, wherein the specific types of events comprising receipt of email, receipt of SMS messages, receipt of incoming calls or the download of songs.

5. The first mobile device of claim 1 wherein the first content is a phone call and wherein the sharing client in the first mobile device controls the sharing of the phone call with at least the second device among the plurality of devices.

6. The first mobile device of claim 1 wherein the first mobile device monitors the sharing of the first content and logs a list of devices among the plurality of devices with whom such sharing occurs, the timestamp of when such sharing occurs, and the details of the recipient devices and associated users with whom such sharing occurs.

7. The first mobile device of claim 1 further comprising:
the sharing client initiates the sharing of the first content, negotiates the transmission of the first content, starts, stops, pauses and controls the sharing of the first content with the those of the plurality of devices that it targets for simultaneously presenting the first content; and
the first device receiving an incoming phone call and sharing it with the plurality of devices after pausing the sharing of the first content for the duration of the incoming phone call.

8. A method employed by a first mobile device for sharing a first content in a network, the method comprising;
determining target mobile devices from a plurality of mobile devices by the first mobile device employing a local sharing manager, wherein the target mobile devices each comprise a corresponding local sharing manager;
soliciting user selection from the target mobile devices, by the local sharing manager of the first mobile device, to assemble a target devices among the plurality of devices with which sharing of the first content will be initiated;
negotiating the transmission of the first content to the target devices, by the local sharing manager of the first mobile device; and
sharing of the first content by the first mobile device.

9. The method of claim 8 wherein the first content is a streaming media, the method further comprising:
determining if at least one of the others of the plurality of devices is currently available and able to receive the streaming media;
sharing of the streaming media upon determining the a list of those currently available; and
terminates sharing of the streaming media by the sharing client of the first mobile device, after determining that no other device is currently able to receive the streaming media.

10. The method of claim 8 further comprising:
receiving, by the sharing client of the first mobile device, an indication of a receipt of an SMS message by an a SMS client, an indication of a receipt of an email message by an email client, or the an indication of a receipt of an instant message by an instant messaging client; and
sharing by the sharing client of the first mobile device, as instructed by a user of the first mobile device, of the associated SMS message, the email message or the instant message, with the others of the plurality of mobile devices.

11. The method of claim 8 further comprising:
receiving, for display to the user of the first mobile device by the sharing client, a first SMS message, a first email message or a first instant message from a second device, wherein the second device is one of the devices among the plurality of devices; and
displaying of the first SMS message, the first email message or the first instant message received from the second device, by employing one of the SMS client, the email client or the instant messaging client, respectively, as appropriate.

12. A network comprising a plurality of devices that communicate, the network comprising:
a first device among the plurality of devices sharing a first content for simultaneous presentation with at least a second device and a third device among the plurality of devices;
the second device communicating a first signal and pausing receipt of the first content shared by the first device in the second device;
the second device subsequently communicating a second signal and resuming receipt of the first content in the second device; and
the first device continuing to share the first content with the second device on resumption until the first device receives a third signal from the second device instructing it to pause or terminate sharing of the first content with the second device.

13. The network comprising of claim 12 wherein the first device continues to share the first content with the third device even when the second device has paused receipt of the first content shared by the first device after communicating the first signal.

14. The network of claim 12 wherein the first content is a phone call and wherein the first device controls the sharing of the phone call with at least the second device among the plurality of devices.

15. The network of claim 12 wherein the first content is one of an instant message, an SMS message and an email message received by the first device.

16. The network of claim 12 wherein the first device monitors the sharing of the first content and logs list of devices among the plurality of devices with whom such sharing occurs, the timestamp of when such sharing occurs, and the details of the recipient devices and associated users with whom such sharing occurs.

17. The network of claim 12 further comprising:
the first device initiates the sharing of the first content, negotiates the transmission of the first content, starts, stops, pauses and controls the sharing of the first content with the those of the plurality of devices that it targets for simultaneously presenting the first content; and
the first device receiving an incoming phone call and sharing it with the plurality of devices after pausing the sharing of the first content for the duration of the incoming phone call.

18. The network of claim 12 further comprising:
each of the plurality of devices comprising a local sharing manager;
the local sharing manager of the first device conducting a discovery process to target devices for sharing wherein, based on user input that is solicited, or based on pre-configured user preferences, the local sharing manager discovers the target devices among the plurality of devices; and
the local sharing manager of the first device negotiating the transmission of the first content to the target devices.

19. The network of claim 12 further comprising:
the local sharing manager of the first device accessing a previously registered list of local sharing participants;
the local sharing manager of the first device determining those from the registered list of local sharing participants who are currently available for sharing and assembling a list of available users;
the local sharing manager of the first device prompting a user to select from the list of available users and determining a target list of devices for local sharing manager of the first content; and
the local sharing manager of the first device sharing the first content with the target list of devices.

20. The network of claim 12 wherein the first content is a streaming media, the network further comprising:
the first device determines if at least one of the others of the plurality of devices is currently available and able to receive the streaming media and upon determining a list of those currently available, starts sharing of the streaming media; and
the first device, after determining that no other device is currently able to receive the streaming media, terminates sharing of the streaming media.
